(19) United States
(12) Patent Application Publication
(10) Pub. No.: US 2025/0094977 A1
(43) Pub. Date: Mar. 20, 2025

(54) Self-Service Controlled Dispensing System and Method

(71) Applicant: PAYRANGE LLC, Portland, OR (US)

(72) Inventors: Paresh K. Patel, Camas, WA (US); Srinivas Annam, San Jose, CA (US)

(21) Appl. No.: 18/963,481

(22) Filed: Nov. 27, 2024

Related U.S. Application Data
(63) Continuation-in-part of application No. 18/610,033, filed on Mar. 19, 2024.
Application No. 18/610,033 is a continuation of application No. 17/443,802, filed on Jul. 27, 2021, now Pat. No. 11,935,051.
Application No. 17/443,802 is a continuation of application No. 16/934,933, filed on Jul. 21, 2020, now Pat. No. 11,074,580.
(63) Continuation-in-part of application No. 18/775,914, filed on Jul. 17, 2024.
Application No. 18/775,914 is a continuation of application No. 18/327,679, filed on Jun. 1, 2023, now Pat. No. 12,043,484.
Application No. 18/327,679 is a continuation of application No. PCT/US22/43357, filed on Sep. 13, 2022.
Application No. PCT/US22/43357 is a continuation of application No. 17/447,499, filed on Sep. 13, 2021, now Pat. No. 12,043,483.
Application No. 17/447,499 is a continuation of application No. 17/447,528, filed on Sep. 13, 2021, now Pat. No. 12,039,581.
Application No. 17/447,528 is a continuation of application No. 17/447,530, filed on Sep. 13, 2021, now Pat. No. 12,045,024.
Application No. 17/447,499 is a continuation-in-part of application No. 17/026,000, filed on Sep. 18, 2020, now Pat. No. 11,663,875.
Application No. 17/447,528 is a continuation-in-part of application No. 17/026,000, filed on Sep. 18, 2020, now Pat. No. 11,663,875.
Application No. 17/447,530 is a continuation-in-part of application No. 17/026,000, filed on Sep. 18, 2020, now Pat. No. 11,663,875.
(60) Provisional application No. 63/620,674, filed on Jan. 12, 2024.
(60) Provisional application No. 63/267,606, filed on Feb. 6, 2022.
(60) Provisional application No. 63/277,104, filed on Nov. 8, 2021.
(60) Provisional application No. 62/985,882, filed on Mar. 5, 2020.
(60) Provisional application No. 63/075,814, filed on Sep. 8, 2020.

(51) Int. Cl. G06Q 20/40; G06F 13/00; G06Q 20/18; G06Q 20/32; G06Q 20/36; G06Q 20/38; G06Q 30/06; G07F 9/00; G07F 9/02

(52) U.S. Cl. CPC G06Q 20/40; G06F 13/00; G06Q 20/18; G06Q 20/32; G06Q 20/322; G06Q 20/3226; G06Q 20/327; G06Q 20/3278; G06Q 20/36; G06Q 20/38; G06Q 20/3821; G06Q 20/3823; G06Q 20/3829; G06Q 20/401; G06Q 20/405; G06Q 30/06; G07F 9/002; G07F 9/023; G06Q 2220/00

(57) ABSTRACT

A self-service controlled dispensing system includes a mobile device configured to verify an age or identity of a user and secure a user account with biometric validation, creating a digital identification based on the verified age or identity, identify one or more controlled dispensing machines in proximity to the mobile device, receive a user selection of a first controlled dispensing machine of the one or more identified controlled dispensing machines, and receive a user request to send a payment to the first controlled dispensing machine. In response to the user request to send the payment to the first controlled dispensing machine, the mobile device validates the user with a biometric check, and transmits the payment and a verification credential corresponding to the digital identification to the first controlled dispensing machine, enabling the first controlled dispensing machine to dispense a controlled product or service to the user.

### RELATED APPLICATIONS

This application claims the benefit of U.S. Provisional Application 63/603,026 (filed Nov. 27, 2023), which is hereby incorporated by reference in its entirety.

This application is also a continuation-in-part of U.S. patent application Ser. No. 18/775,914 (filed Jul. 17, 2024), which is a continuation of U.S. patent application Ser. No. 18/327,679 (filed Jun. 1, 2023), which is a continuation of International Patent Application PCT/US22/43357 (filed Sep. 13, 2022), which claims the benefit of U.S. Provisional Applications 63/267,606 (filed Feb. 6, 2022) and 63/277,104 (filed Nov. 8, 2021), and which is a continuation of U.S. application Ser. No. 17/447,499 (filed Sep. 13, 2021), Ser. No. 17/447,528 (filed Sep. 13, 2021), and Ser. No. 17/447,530 (filed Sep. 13, 2021), each of which is a continuation in part of U.S. application Ser. No. 17/026,000 (filed Sep. 18, 2020), which claims the benefit of U.S. Provisional Applications 62/985,882 (filed Mar. 5, 2020) and 63/075,814 (filed Sep. 8, 2020). Each of the aforementioned patent applications is hereby incorporated by reference in its entirety.

This application is also a continuation-in-part of U.S. patent application Ser. No. 18/610,033 (filed Mar. 19, 2024), which is a continuation of U.S. patent application Ser. No. 17/443,802 (filed Jul. 27, 2021), which is a continuation of U.S. patent application Ser. No. 16/934,933, each of which is hereby incorporated by reference in its entirety.

This application is related to U.S. patent application Ser. No. 18/643,965 (filed Apr. 23, 2024); Ser. No. 18/952,804 (filed Nov. 19, 2024); Ser. No. 18/888,102 (filed Sep. 17, 2024); Ser. No. 18/830,424 (filed Sep. 10, 2024); Ser. No. 18/952,778 (filed Nov. 19, 2024); Ser. No. 18/951,218 (filed Nov. 18, 2024); Ser. No. 18/888,036 (filed Sep. 17, 2024); and Ser. No. 18/636,314 (filed Apr. 16, 2024), each of which is hereby incorporated by reference in its entirety.

### TECHNICAL FIELD

The present application relates to the field of controlled dispensing machines, and in particular, to a system for restricting the purchase and use of controlled products and services to individuals who are authorized to use them.

### BACKGROUND

Selling age-restricted products presents particular issues and there must be effective systems in place for preventing sales to prospective consumers who are underage. Since young people often seek to discover ways to evade proof-of-age checks and obtain age-restricted products, sales of such products have traditionally required a live person at the point of sale to request valid proof of age to confirm that the purchaser is over the minimum age to buy the product in question.

Unattended retail has seen a remarkable transformation in recent years, driven by several key trends. The aftermath of the COVID-19 pandemic left businesses grappling with labor shortages, prompting the need for automation in various industries. Consumers now desire more automated, personalized, and fully controlled experiences, and digital technology is pivotal in making commerce seamless and frictionless. Digital payments, automated processes, AI-powered sales predictions, and augmented reality are all part of this digital transformation. These technologies focus on automating, simplifying, and removing as many low-value manual processes as possible to lower employees' workload and free up time for more valuable tasks.

While self-service solutions have continued to advance in response to these trends, one critical area remains left behind-self-service for adult beverages like beer, hard seltzers and wine. Attempts to fully automate adult beverage dispensing in hospitality venues, such as airports, stadiums, hotels, and casinos have fallen short. Current solutions are cumbersome and unreliable, require expensive hardware, and add unnecessary complexity to the consumer self-checkout experience. Many current “pour my own” systems still rely on manual labor to verify age or require complicated ID scanners, facial cameras, network connections, and payment terminals, further complicating the self-service experience.

Some solutions have integrated age-verification hardware onto the machine itself, but these often fall short of expectations. On-machine cameras, typically exorbitant in price, struggle when lighting conditions are not perfect. Expensive hardware also becomes targets for vandals. But what's worse, the user experience suffers, laden with friction at the checkout. At self-serve alcohol pour stations, customers frequently return for that second round, and today's solutions leave them endlessly re-verifying their age at checkout.

These demands present significant barriers for operators looking to scale their self-serve beverage solutions and compete with the overall goal of self-service operations: automating, simplifying, and removing as many low-value manual processes as possible to lower the workload of employees and free up time for more valuable tasks. Moreover, today's solutions lack the necessary responsibility and compliance measures, such as preventing over-serving, required to sell adult beverages responsibly.

### SUMMARY

Disclosed herein is a controlled dispensing system for restricting the purchasing, release, and usage of controlled products to authorized users. The disclosed system is a game-changing innovation that turns traditional adult beverage pour stations into smart, mobile, compliant self-pour stations, all through the convenience of a user's smartphone. With the disclosed system, no expensive hardware or connectivity is required. The system can be easily installed on any beverage system in seconds and instantly transforms it into a compliant self-serve automated pour station. With this solution, the disclosed system leverages the connectivity of the user rather than relying on machine connectivity.

The disclosed system improves the field of self-serve adult beverages, bridging the gap between operators and consumers and creating a seamless, secure, and responsible dispensing experience. The disclosed system enables users to verify their age using an in-app age verification service, ensuring that every sale is a responsible and compliant transaction. The disclosed system's built-in over-serving controls ensure operators can responsibly sell unattended adult beverages. Customers send their payments directly through the app, making the process convenient and secure. The disclosed system eliminates the barriers that often hinder the scalability of self-serve stations, thereby making it possible to streamline the transaction process, enhance the overall customer experience, and meet the growing consumer demand for self-serve options while providing a responsible and compliant approach to alcohol service.

In addition to alcoholic beverage self-service, the disclosed system enables compliant self-service for any other product or service for which usage is controlled by an age restriction (e.g., cigarettes, tobacco products, cannabis products, cannabidiol (CBD), vaping products, e-liquids, electronic cigarettes, nicotine pouches, nicotine gum, dietary supplements, alcohol, lottery tickets, firearms, and so forth). An example controlled product or service may additionally or alternatively be subject to other kinds of restriction, such as security restrictions (e.g., inventory-controlled products that may have a relatively high tendency to be stolen, such as contraceptives, razor blade refills, spray paint, baby formula, calling cards, cough syrup, pharmaceutical products, and so forth), identity restrictions (e.g., products authorized for a specified individual such as a prescription medication or other pharmaceutical product), and/or quantity restrictions (e.g., products limited to a certain number of purchases or items to a consumer in any given period of time).

Disclosed herein are various implementations of systems and methods for dispensing controlled products or, more specifically, systems and methods for restricting the purchase and/or use of controlled products to individuals who are authorized to use them based on identity-based and/or age-based restrictions associated with the controlled products.

### BRIEF DESCRIPTION OF THE DRAWINGS

FIG. 1 is a diagram of a controlled dispensing environment in accordance with some implementations.

FIG. 2 is a diagram of a control unit of a controlled dispensing machine in accordance with some implementations.

FIG. 3 is a diagram of a mobile device in accordance with some implementations.

FIG. 4 is a diagram of a server system in accordance with some implementations.

FIG. 5 is a flow diagram of a self-serve dispensing validation method at a mobile device in accordance with some implementations

FIG. 6 is a flow diagram of a self-serve dispensing validation method involving a controlled dispensing machine, a mobile device, and a server system in accordance with some implementations.

FIGS. 7A-7D are diagrams depicting example user interfaces of a mobile device associated with a self-serve controlled dispensing environment in accordance with some implementations.

Like reference numerals refer to corresponding parts throughout the several views of the drawings.

### DETAILED DESCRIPTION

Disclosed herein are various implementations of systems and methods for dispensing and activating controlled products or, more specifically, systems and methods for restricting the purchase and use of controlled products to individuals who are authorized to use them.

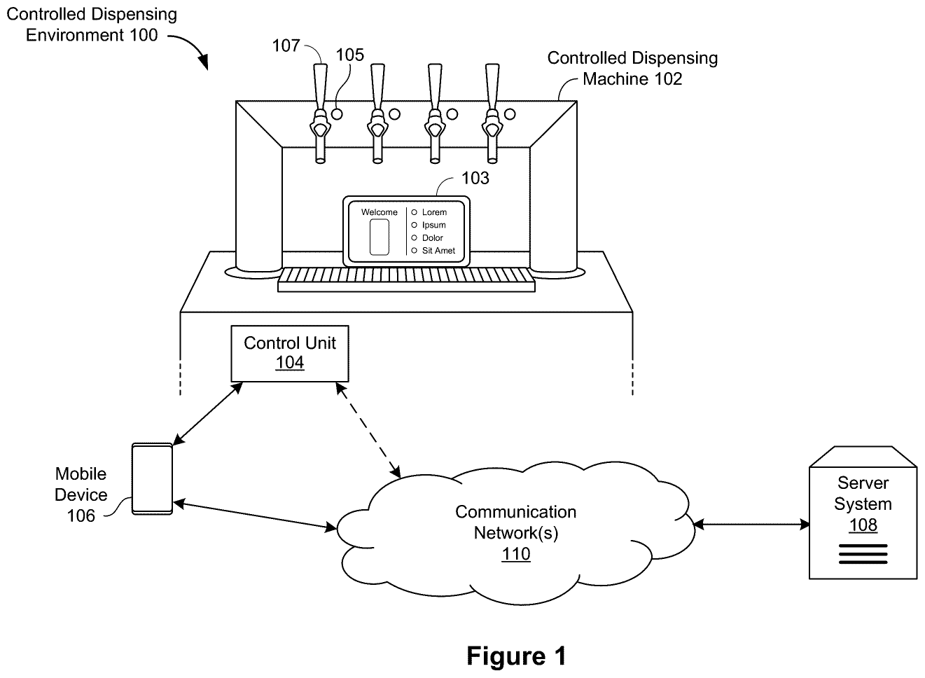

FIG. 1 is a diagram of a controlled dispensing environment 100 in accordance with some implementations. The environment 100 includes a controlled dispensing machine 102 including a control unit 104, a mobile device 106, and a server system 108. The mobile device 106 communicates with the server system 108 over one or more communication networks 110 such as the Internet. In some implementations, the control unit 104 also communicates with the server system 108, but this is optional. In some implementations, the control unit 104 communicates with a server system (not shown) that is independent from server system 108. For example, from the perspective of the controlled dispensing machine 102, the independent server system may be associated with a payment service and/or business associated with the product stocked in the controlled dispensing machine 102, while the server system 108 may be associated with a third-party controlled dispensing application installed on the mobile device 106 and a third-party controlled dispensing module coupled to the control unit 104 that enables self-service dispensing of the product by facilitating age verification and/or access control.

The controlled dispensing machine 102 is a machine configured to store one or more controlled products or services and release them, or otherwise make them available, to consumers. The machine 102 may be a vending machine or any other device that stores products or services and dispenses the products or services as a result of transactions involving consumers. In the example illustrated in FIG. 1, the controlled dispensing machine 102 is a self-pour adult beverage dispenser (sometimes referred to as a beer tap). The machine 102 can be a wall-mount machine, placed on the ground, or mounted to the top of a case (e.g., storing adult beverages for dispensing to consumers). The machine 102 may have a digital display screen on which instructions are displayed for interacting with the machine, either via the display panel or through a third-party app.

The product or service provided by the machine 102 may be any product that is associated with a usage restriction. An example usage restriction is an age restriction (e.g., may only be used by those who are 18 and up, 21 and up, or whatever the case me be). Controlled products or services may additionally or alternatively be restricted in other ways, such as by identity (e.g., may only be used by a particular individual), by quantity or usage, or by any other type of attribute associated with one or more individuals. Example controlled products include electronic cigarettes (e-cigs), electronic vaporizers (vaping pens or vape pens), or any other product including a controlled substance such as tobacco, nicotine, alcohol, marijuana, and so forth. Controlled products or services may be associated with medicine or any other type of age-restricted substance. Controlled products or services may be meant for individuals who need to be tracked by the seller or manufacturer, or for whom the transaction itself needs to be tracked by the seller or manufacturer (e.g., for compliance purposes). For example, controlled products may include communication devices (phones, sim cards, and so forth) which are meant to be sold to adults only, or to individuals for whom the transaction needs to be tracked.

The mobile device 106 is a personal electronic device associated with the consumer (e.g., the consumer's smartphone). Mobile devices 106 include, but are not limited to, smart phones, tablet or laptop computers, or personal digital assistants (PDAs), smart cards, or voice assistant devices (such as Alexa), or other technology (e.g., a hardware-software combination) known or yet to be discovered that has structure and/or capabilities similar to the mobile devices described herein. The mobile device 106 includes a long-range communication capability (e.g., modem, transceiver, and so forth) for communicating through the network(s) 110, and a short-range communication capability (e.g., BLE) for communicating with the control unit 104 and other devices in range of a short-range radio (e.g., Bluetooth radio) of the mobile device 106. Communications between the mobile device 106 and the controlled unit 104 take place using short-range communication technology or short-range communication protocol (e.g., Bluetooth (such as Bluetooth 4.0, Bluetooth Smart, Bluetooth Low Energy (BLE)), near-field communication (NFC), Ultra Wideband (UWB), radio frequency identification (RFID), infrared wireless, induction wireless, WiFi, or any wired or wireless technology that could be used to communicate a small distance (e.g., approximately a hundred feet or closer) that is known or yet to be discovered). The communications technologies described herein may be replaced with alternative communications technologies and, therefore, specific communications technologies are not meant to be limiting. For example, Wi-Fi technology could be replaced with another long-range communications technology.

The server system 108 communicates with the mobile device 106 through the communication network(s) 110. The server system 108 stores user accounts associated with applications installed on mobile devices 106 of consumers. For each user account, the server system 108 may maintain a virtual wallet having a balance (which can be $0) of designated funds for which the server system 108 keeps an accounting. The balance may represent, for example, cash or it may be a promotional value that represents funds that may be spent under certain circumstances. If these funds begin to be depleted, the consumer may be notified (e.g., via an application on the mobile device 106 or via an electronic communication) that additional funds need to be designated and/or transferred. Alternatively, funds from other sources (e.g., a funding source server) may be automatically transferred to restore a predetermined balance.

The mobile device 106 and server system 108 are communicatively coupled to each other by one or more communication networks 110. The communication network(s) 110 are configured to convey communications (messages, signals, transmissions, and so forth). The communications include various types of information and/or instructions including, but not limited to, data, commands, bits, symbols, voltages, currents, electromagnetic waves, magnetic fields or particles, optical fields or particles, and/or any combination thereof. The communication network(s) 110 use one or more communication protocols, such as any of Wi-Fi, Bluetooth, Bluetooth Low Energy (BLE), near-field communication (NFC), ultra-wideband (UWB), radio frequency identification (RFID), infrared wireless, induction wireless, ZigBee, Z-Wave, 6LoWPAN, Thread, 4G, 5G, and the like. Such protocols may be used to send and receive the communications using one or more transmitters, receivers, or transceivers. For example, hard-wired communications (e.g., wired serial communications) may use technology appropriate for hard-wired communications, short-range communications (e.g., Bluetooth) may use technology appropriate for close communications, and long-range communications (e.g., GSM, CDMA, Wi-Fi, wide area network (WAN), local area network (LAN), or the like) may use technology appropriate for remote communications over a distance (e.g., over the Internet). In general, the communication network(s) 110 may include or otherwise use any wired or wireless communication technology that is known or yet to be discovered.

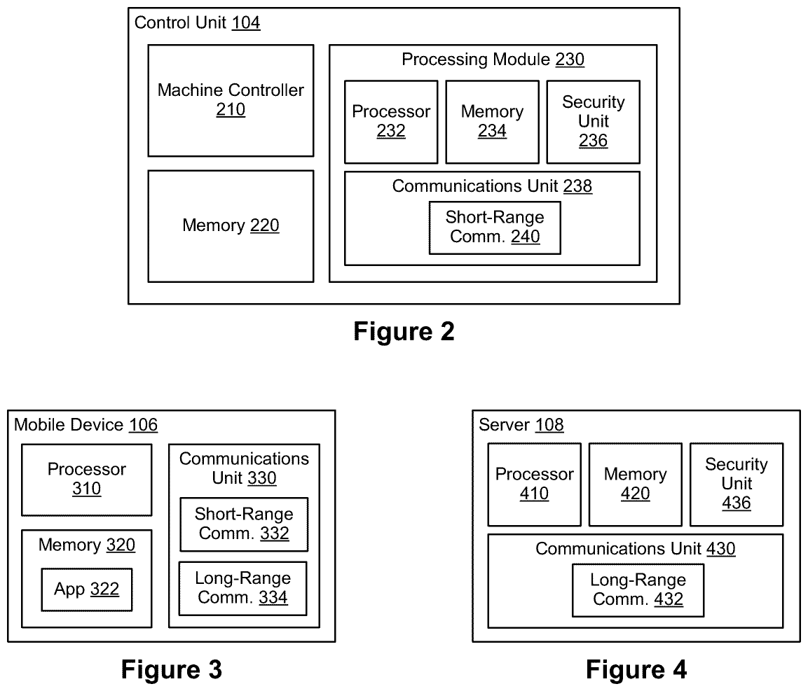

FIG. 2 is a block diagram of a control unit 104 in accordance with some implementations. The control unit 104 includes a machine controller 210, memory 220, and a processing module 230.

The machine controller 210 includes one or more processors and all of the electronic circuitry required to operate the local (on-board) functions of the controlled dispensing machine 102. Such circuitry is specific to the type of machine 102 and the details are not pertinent to this disclosure. However, as an illustrative example, if the machine 102 is a beer tap, then the controller 210 may include one or more processors configured to execute programs stored in the memory 220 that cause the one or more processors to: facilitate local payments and beer selections on an input device 103, control indicator lights 105 that signal which taps 107 are available for pouring, and control internal pumps that cause the different beer offerings to be provided to respective taps 107. In various implementations, the machine controller 210 may be part of the processing module 230 or separate but communicatively coupled to the radio module. In various implementations, some functions of the machine controller 210 may be performed by a processor 232 embedded in the processing module 230, and some functions of the processor 232 may be performed by the machine controller 210.

The memory 220 may include or consist essentially of one or more volatile or non-volatile storage devices, e.g., random-access memory (RAM) devices such as DRAM, SRAM, etc., read-only memory (ROM) devices, magnetic disks, optical disks, flash memory devices, and/or other solid-state memory devices. All or a portion of the memory may be located remotely from the control unit 104, e.g., as one or more storage devices connected to the control unit 104 via a network (e.g., Ethernet, WiFi, a cellular telephone network, the Internet, or any local- or wide-area network or combination of networks capable of supporting data transfer and communication). As utilized herein, the term “storage” broadly connotes any form of digital storage, e.g., optical storage, magnetic storage, semiconductor storage, etc.

The processing module 230 includes a processor 232, memory 234, security unit 236, and communications unit 238 including short-range communication capability 238. In some implementations, the control unit 104 only includes the processing module 230 including short-range communication capability 240 and processor 232 (e.g., in a system-on-chip (SOC) implementation). In some implementations, the processing module 230 does not use or require a separate processor 232. In some implementations, the processing module 230, the processor 232, the memory 234, the security unit 236, and the communications unit 238 are all part of an SOC implementation (e.g., an all-in-one unit). In some implementations, the processing module 230 is an adaptor that may be communicatively coupled to the machine controller 210 as an after-market item, providing additional capabilities to the controlled dispensing machine 102 (e.g., compliant self-service capabilities including age verification and mobile payment functions).

The security unit 236 may encrypt and decrypt messages between the control unit 104 and the server system 108 using a unique private key, public/private keys (i.e., asymmetric cryptography), or other encryption/decryption strategies known or yet to be discovered. For example, a unique private key may be used to securely transmit encrypted messages between the control unit 104 and the server system 108 (although the encrypted transmissions would most likely be routed through the mobile device 106). In some implementations, the server system 108 stores a private key for each control unit 104, and this key is only known to the control unit 104 and the server system 108. No intermediary is privy to this key (especially not the mobile device 106). When the control unit 104 and the server system 108 communicate messages (e.g., authorization request and authorization grant messages), the security unit 236 of the control unit 104 encrypts the message with its private key and passes the message to the mobile device 106. The mobile device 106 (which preferably cannot decrypt the message) passes the encrypted message to the server system 108. The security unit 436 of the server system 108 is able to decrypt the message using the unique private key. The security unit 436 of the server system 108 uses this same unique private key to encrypt messages to the control unit 104 and sends the message to the mobile device 106 to relay to the control unit 104, which is able to decrypt the message using the security unit 236 and the unique private key. The security unit 236 may be a module in memory 236 or a separate security module, configured to cause the processor 232 to implement the encryption and decryption functions described herein.

In some implementations, the processing module 230 is an adapter or payment module configured to perform one or more of the functions described with reference to any of the modules 100, 1300, 1520, and 124 described in U.S. patent application Ser. No. 18/643,965 (FIGS. 1-31B); Ser. No. 18/952,804 (FIGS. 1-26B); Ser. No. 18/888,102 (FIGS. 1-30D); Ser. No. 18/830,424 (FIGS. 1-30D); Ser. No. 18/952,778 (FIGS. 1-33); Ser. No. 18/951,218 (FIGS. 1-30); Ser. No. 18/888,036 (FIGS. 1-58); Ser. No. 18/636,314 (FIGS. 1-12C); and Ser. No. 18/610,033 (FIGS. 1-35B). Each of the aforementioned patent applications is hereby incorporated by reference in its entirety, the operations of which are not repeated here for the sake of brevity.

FIG. 3 is a block diagram of a mobile device 106 in accordance with some implementations. The mobile device 106 is a personal electronic device associated with the consumer (e.g., the consumer's smartphone), and it includes a processor 310, a memory 320 storing a mobile payment and/or consumer verification application 322, and a communications unit 330. Mobile devices 106 include, but are not limited to, smartphones, tablet or laptop computers, personal digital assistants (PDAs), smart cards, voice assistant devices (such as Alexa), or other technology (e.g., a hardware-software combination) known or yet to be discovered that has structure and/or capabilities similar to the mobile devices described herein. The communications unit 330 includes a long-range communication capability (e.g., modem, transceiver, and so forth) for communicating through the network(s) 110 and a short-range communication capability (e.g., BLE) for communicating with the control unit 104 and other devices in range of a short-range radio (e.g., Bluetooth radio) of the mobile device 106. Communications between the mobile device 106 and the control unit 104 take place using short-range communication technology or short-range communication protocol (e.g., Bluetooth (such as Bluetooth 4.0, Bluetooth Smart, Bluetooth Low Energy (BLE)), near-field communication (NFC), Ultra Wideband (UWB), radio frequency identification (RFID), infrared wireless, induction wireless, WiFi, or any wired or wireless technology that could be used to communicate a small distance (e.g., approximately a hundred feet or closer) that is known or yet to be discovered). The communications technologies described herein may be replaced with alternative communications technologies and, therefore, specific communications technologies are not meant to be limiting. For example, Wi-Fi technology could be replaced with another long-range communications technology.

The mobile device 106 may act as a communication bridge between the control unit 104 and the server system 108. In some implementations, the mobile device 106 and the application 322, however, are not “trusted” in that the communications (transmissions) they pass are encrypted. Encrypted (secured) communications are undecipherable (unencryptable, unreadable, and/or unusable) by the mobile device 106. This keeps the communications passed between the machine 102 and the server system 108 secured and safe from hacking.

In some implementations, the mobile device 106 may be configured to perform one or more of the functions described with reference to any of the mobile devices (e.g., mobile device 150) described in U.S. patent application Ser. No. 18/643,965 (FIGS. 1-31B); Ser. No. 18/952,804 (FIGS. 1-26B); Ser. No. 18/888,102 (FIGS. 1-30D); Ser. No. 18/830,424 (FIGS. 1-30D); Ser. No. 18/952,778 (FIGS. 1-33); Ser. No. 18/951,218 (FIGS. 1-30); Ser. No. 18/888,036 (FIGS. 1-58); Ser. No. 18/636,314 (FIGS. 1-12C); and Ser. No. 18/610,033 (FIGS. 1-35B). Each of the aforementioned patent applications is hereby incorporated by reference in its entirety, the operations of which are not repeated here for the sake of brevity.

In some implementations, the processing module 230 is as an adapter module configured as a plug-and-play solution that integrates into an existing machine 102 by physically and/or communicatively coupling to the main bus of the control unit 104 and communicating with the machine controller 210 and other peripherals of the machine via the main bus. For example, the processing module 230 may correspond to and be implemented as device 1300 in U.S. patent application Ser. No. 18/610,033 (FIGS. 26-34) (incorporated by reference). Specifically, processing module 230 may be coupled to the machine controller 210 via a main bus. While the main bus is a multidrop bus (MDB) in FIG. 26 of the Ser. No. 18/610,033 application (incorporated by reference), the main bus in the present disclosure may be implemented using any communication protocol. As a result of this implementation, the processing module 230 may provide the mobile device 106 with access to peripherals of the machine 102, such as the display 103 and/or any payment devices integrated into the machine 102. That way, the processing module 230 may perform as a peripheral to the machine controller 210 (e.g., by providing a “payment”) and perform as a machine controller for one or more peripherals (e.g., by controlling the display 103). The processing module 230 may perform as a peripheral and as a machine controller according to any of the implementations described in FIGS. 29-34 of the Ser. No. 18/610,033 application (incorporated by reference).

FIG. 4 is a block diagram of a server system 108 in accordance with some implementations. The server system 108 includes one or more processors 410, memory 420, communications unit 430, and a security unit 436. The communications unit 430 of the server system 108 includes long-range communication capability 432 (e.g., cellular technology and/or Wi-Fi mechanisms). In some implementations, the security unit 436 is configured for encrypting and decrypting messages. The security unit 436 may be a module in memory 420 or a separate security module, configured to cause the processor 410 to implement the encryption and decryption functions described herein. The functions of the server system 108 are described in more detail below.

In some implementations, the server system 108 includes a plurality of distinct server systems. In some implementations, some server functions may be managed, configured, and/or specified by a third party that provides product validation services for OEMs (original equipment manufacturers) and retailers, and the server functions may be managed, configured, and/or specified by one or more OEMs with respect to protected products manufactured by respective OEMs. The server system 108 may include one or more host processing servers operated by a company associated with the seller of control units 104 and/or processing modules 230. In some implementations, the server system 108 may maintain a virtual wallet for each consumer having a balance (which can be $0) of designated funds for which the server system 108 keeps an accounting. The balance may represent, for example, cash or it may be a promotional value that represents funds that may be spent under certain circumstances. If these funds begin to be depleted, the consumer may be notified (e.g., via an application on the mobile device 106 or via an electronic communication) that additional funds need to be designated and/or transferred. Alternatively, funds from other sources (e.g., a funding source server) may be automatically transferred to restore a predetermined balance.

In some implementations, the server system 108 is configured to perform one or more of the functions described with reference to any of the server systems (e.g., server system 130) described in U.S. patent application Ser. No. 18/643,965 (FIGS. 1-31B); Ser. No. 18/952,804 (FIGS. 1-26B); Ser. No. 18/888,102 (FIGS. 1-30D); Ser. No. 18/830,424 (FIGS. 1-30D); Ser. No. 18/952,778 (FIGS. 1-33); Ser. No. 18/951,218 (FIGS. 1-30); Ser. No. 18/888,036 (FIGS. 1-58); Ser. No. 18/636,314 (FIGS. 1-12C); and Ser. No. 18/610,033 (FIGS. 1-35B). Each of the aforementioned patent applications is hereby incorporated by reference in its entirety, the operations of which are not repeated here for the sake of brevity.

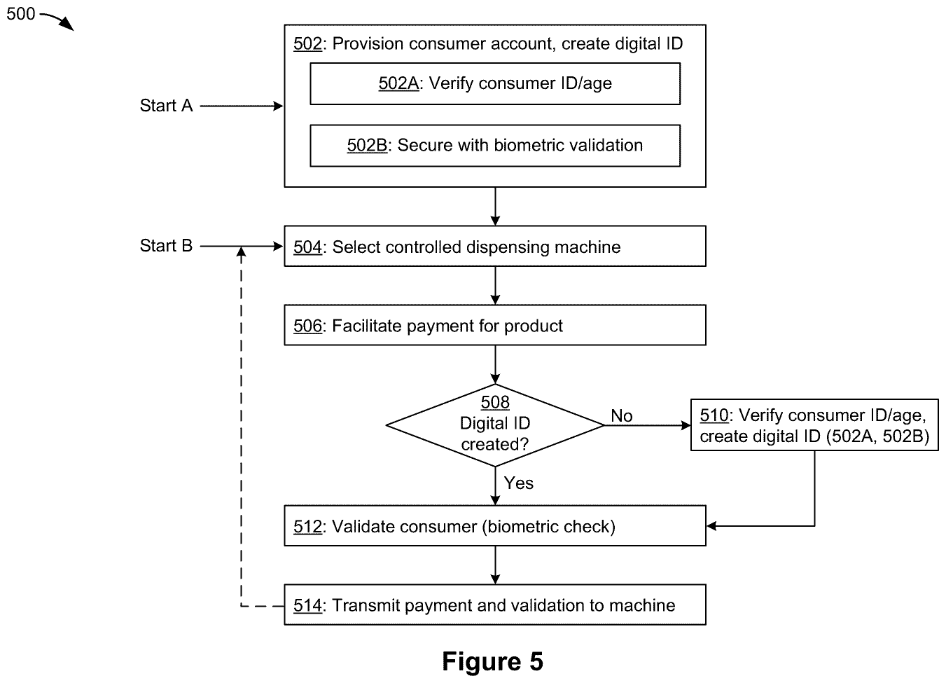

FIG. 5 is a flow diagram of a self-serve dispensing validation method 500 at a mobile device in accordance with some implementations. The method 500 may be governed by instructions that are stored in a memory or non-transitory computer readable storage medium of a mobile device (e.g., memory 320 of mobile device 106) and that are executed by one or more processors of the mobile device (e.g., processor 310). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in the method 500 may be combined and/or the order of some operations may be changed. Optional operations are conveyed with dashed lines.

In general, the mobile device 106 executes an application (e.g., 322) that verifies and validates consumer information, facilitates purchases of controlled products and/or services from controlled dispensing machines 102, and facilitates communications with the server system 108 via the communication network(s) 110. If the consumer is a user of the application, the consumer can use the application to purchase a controlled product and/or service at a desired machine 102 while allowing the application to validate the consumer's age and/or identity. The consumer provides identity and/or age verification by performing biometric verification on the consumer's mobile device 106 (e.g., using touch ID, face ID, or something similar) to validate that the consumer is the owner of the mobile device 106. Since the consumer is validated as being the owner of the mobile device 106 (after performing the biometric verification), the mobile device 106 is associated with the consumer's account (since the application installed), the consumer's identity and/or age has been verified using the consumer's account (by having performed verification procedures 502 or 510), it may be concluded that the consumer satisfies age and/or identity requirements associated with the desired controlled product and/or service. This presumption may be solely based on the consumer passing the biometric verification on the mobile device through the application 322 and does not require additional steps such as presenting a physical identification card.

The dispensing machine 102 then dispenses the controlled product and/or provides the controlled service based on the consumer validation and purchase. As a result of this method, once a consumer's account is validated (e.g., verified that the mobile device belongs to the consumer and the consumer meets an age and/or identity threshold), then the consumer is not required to use a physical ID card for purchases of controlled products and/or services, as long as the consumer continues to use the same mobile device as described herein. This method is advantageous from a data privacy perspective, since an employee (e.g., a hotel clerk or retailer) would not be required to view or process consumer data (e.g., would not need to send consumer data to any servers or query any databases with inquiries). Instead, the consumer just validates his or her age and/or identity using his or her mobile device, which automatically authorizes dispensing of the controlled product and/or service while conforming to age-based and/or identity-based regulations associated with the controlled product and/or service.

Specifically, referring to FIG. 5, the consumer may begin at Start A (operation 502) by using his or her phone (e.g., mobile device 106) to provision a consumer account and create a digital ID before going to the location at which the dispensing machine 102 is located (e.g., prior to going to a hotel lobby where a self-serve beer tap is located). By doing so, the consumer can save time and have adding convenience without compromising on age-based or identity-based compliance measures surrounding the sale of controlled products from the perspective of the location (e.g., the hotel) or the product manufacturer (e.g., the beer supplier).

Alternatively, the consumer may begin at Start B (operation 504) by downloading a mobile app (e.g., 322) associated with machine (e.g., associated with processing module 230 of machine 102) in response to seeing instructions at the location of the machine. By doing so, the consumer can proceed to procure the controlled product or service on the spot, even if the consumer did not first provision an account at home, without compromising on age-based or identity-based compliance measures surrounding the sale of controlled products from the perspective of the location (e.g., the hotel) or the product manufacturer (e.g., the beer supplier). In this scenario, the account provisioning and consumer validation steps would take place in operation 510.

Regardless of whether the account provision and associated digital ID creation takes place in operation 502 or 510, this step need only be followed once. That way, the consumer may proceed to obtain additional products or services from the machine 102 without having to continually re-verify identity and/or age with the server system 108, thus saving time, adding convenience, and increasing potential business by making it easier for consumers to purchase more products and/or services.

In operation 502, the consumer creates an account and performs a one-time age and/or identity verification (502A), which can be performed through an external service which requires, for example, the consumer to upload a copy of his or her driver's license and/or upload a live image of the consumer's face (sometimes referred to as a live selfie) for remote verification of identity and/or age. An example age and/or identity verification (without live verification) is described with reference to FIGS. 28A-28H of U.S. patent application Ser. No. 18/775,914 (incorporated by reference). An example age and/or identity verification (with live verification) is described with reference to FIGS. 28A-28Q of U.S. patent application Ser. No. 18/775,914 (incorporated by reference).

Alternatively, one or more identity and/or age verification steps may be performed in person at the location of the machine 102. For example, in some implementations, the consumer may be required to show a physical ID to an employee, who validates and verifies the ID as described with reference to operations 1406 and 1406A in U.S. patent application Ser. No. 18/775,914 (incorporated by reference). For subsequent product dispensing operations (e.g., involving subsequent uses of the machine 102 by the consumer), the consumer's identity and/or age may be verified solely with the mobile device 106 (e.g., by logging into the consumer's account and performing a biometric verification), rather than an employee having to request a physical ID again.

Optionally, the dispensing machine 102 or dispensing application running on the mobile device 106 may randomly ask for physical ID anyway (as part of a random spot check to ensure compliance with identity and/or age-based restrictions). These subsequent physical ID checks may be random or based on risk factors (e.g., purchase quantities). For example, if the consumer buys more than a threshold of controlled products per unit of time (e.g., more than five beers in one hour), the consumer may be prompted to show physical ID to make sure the consumer, the mobile device 106, and the consumer account are still linked. Positive results of such checks (e.g., the physical ID is confirmed to be that of the consumer linked to the account and the mobile device 106), may increase confidence in that consumer for subsequent purchases of controlled products, thereby lowering a risk score associated with the consumer, thus requiring less frequent physical ID checks.

As part of the consumer account provisioning in operation 502, the consumer may be required to secure (502B) the account with a biometric validation feature of the mobile device 106 (e.g., any of face ID, touch ID, and so forth). For example, the application may prompt the user to use a built-in biometric validation feature to access the application for subsequent purchases of controlled products. Thus, the consumer account (which is associated with a verified identity and/or age) is linked to the consumer, and the consumer is linked to the mobile device 106 on which the consumer account is accessed. Stated another way, as a result of operation 502B, the consumer is linked to the mobile device 106 on which the consumer accesses his or her account, and as a result of operation 502A, the consumer's identity and/or age is verified through the consumer's link to the account. Thus, the consumer, the mobile device 106, and the verified account are all linked as a result of operations 502.

As part of account provisioning operations 502, the application may create a digital ID associated with the linked consumer's age and/or identity. The application 322 may store this digital ID in the memory 320 using a mobile wallet application. In some implementations, the application 322 may store this digital ID in the memory by using the application 322 itself (without requiring a third-party mobile wallet application). Regardless of how the digital ID is stored, the application 322 retrieves the digital ID from the memory 320 when it is time for the consumer to validate himself or herself in operation 512.

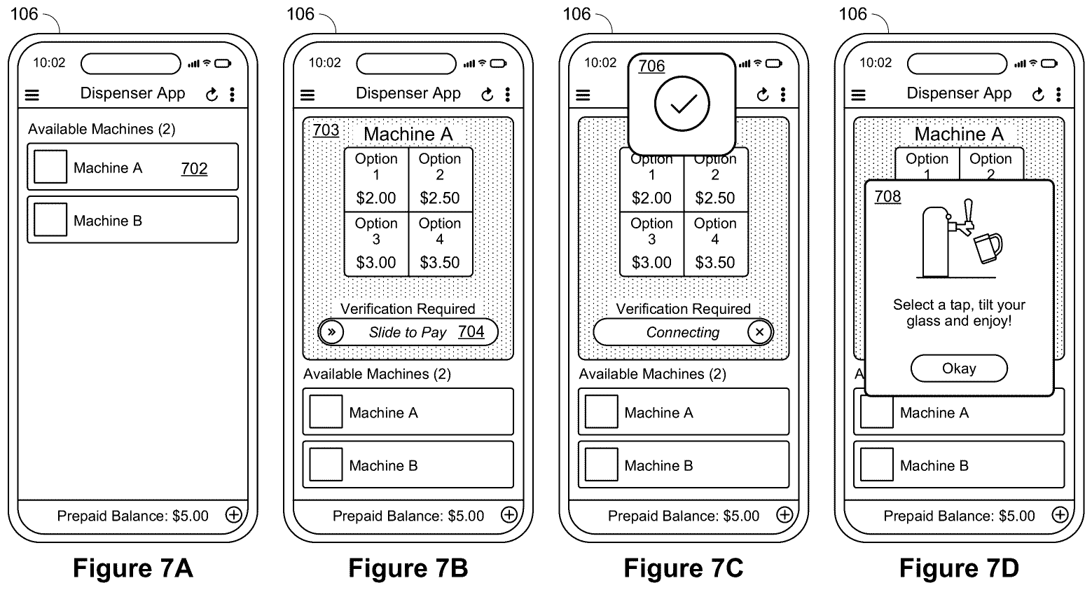

Once the consumer account is provisioned in operations 502 (thereby linking the consumer with the consumer account and the mobile device 106), method 500 continues with selection (504) of a controlled dispensing machine 102. Example machine selection processes are described in U.S. patent application Ser. No. 18/643,965 (FIGS. 1-31B); Ser. No. 18/952,804 (FIGS. 1-26B); Ser. No. 18/888,102 (FIGS. 1-30D); Ser. No. 18/830,424 (FIGS. 1-30D); Ser. No. 18/952,778 (FIGS. 1-33); Ser. No. 18/951,218 (FIGS. 1-30); Ser. No. 18/888,036 (FIGS. 1-58); Ser. No. 18/636,314 (FIGS. 1-12C); and Ser. No. 18/610,033 (FIGS. 1-35B), each of which is incorporated by reference. The aforementioned applications describe various method of identifying an adapter module, payment module, or device 100, 1300, 1520, or 124. In the present disclosure, the control unit 104 (or the processing module 230) may advertise (e.g., broadcast) a signal similar to that broadcasted by module/device 100, 1300, 1520, or 124 in the aforementioned applications, allowing the mobile device 106 to identify machines 102 in range and/or machines 102 available for interaction with the consumer. Alternatively, an identifier (e.g., a number or QR code) may be physically displayed in proximity to the machine 102, allowing the consumer to manually search for the machine by entering into the application 322 in a machine search interface. Alternatively, the consumer may enter a location in a machine search interface and select the desired machine from a list of available machines at that location. Alternatively, the application 322 may transmit the location of the mobile device 106 to the server system 108 and receive a list of available machines at that location without requiring the consumer to manually provide the location information. An example machine selection interface is depicted in FIG. 7A, which shows two machines (Machine A and Machine B) in proximity to the mobile device 106. This interface and associated list of available machines may be the result of any of the aforementioned machine identification methods.

Once the particular machine 102 has been selected, method 500 continues with payment (504) and validation (512) operations. These operations can happen in any order. If account provision, consumer verification, and digital ID creation (operations 502) occurred prior to operation 504 (Start A), then the validation operation (512) may proceed without repeating those steps (508—Yes). If account provision, consumer verification, and digital ID creation (operations 502) did not occur prior to operation 504 (Start B), then those steps (510) must occur prior to, or as a part of, the validation operation 512 (508—No).

Regarding the payment operation 506, in some implementations, the server system 108 maintains a virtual wallet having a balance of designated funds for which the server system 108 keeps an accounting. Funds (e.g., from a funding source server) may be transferred to the virtual wallet to maintain a balance. In some implementations, the user may interact with a user interface element (shown in FIG. 7B as a “slide to pay” element 704) in order to commence the payment process. The user interface element may take any form, as long as it facilitates user selection of an option to proceed with sending a payment. The payment may be sent either directly to the machine 102 or to a server associated with the machine 102 thereby causing the server to communicate to the machine that payment has been made.

Regarding the validation operation 512, the mobile application 322 performs a biometric validation operation (e.g., any of face ID, touch ID, and so forth) to ensure that the person accessing the mobile application 322 is the same person who provisioned the consumer account in operations 502 (and thus satisfies identity and/or age requirements associated with the controlled products and/or services). While the account provision and consumer verification operations 502 are for the purpose of initial verifications and digital ID setup (and can thus take place at any time prior to operation 512), the biometric check in operation 512 verifies the identity and/or age of the consumer just prior to the dispensing operation. The biometric check in operation 512 verifies the identity and/or age of the consumer using the reusable digital ID created in operations 502 or 510.

In some implementations, the validation operation 512 must occur prior to sending payment to the machine 102. Thus, as a result of a successful consumer validation operation 512, the application 322 transmits the payment and validation (e.g., identity and/or age-verified credentials) to the machine 102 via the processing module 230 of its control unit 104.

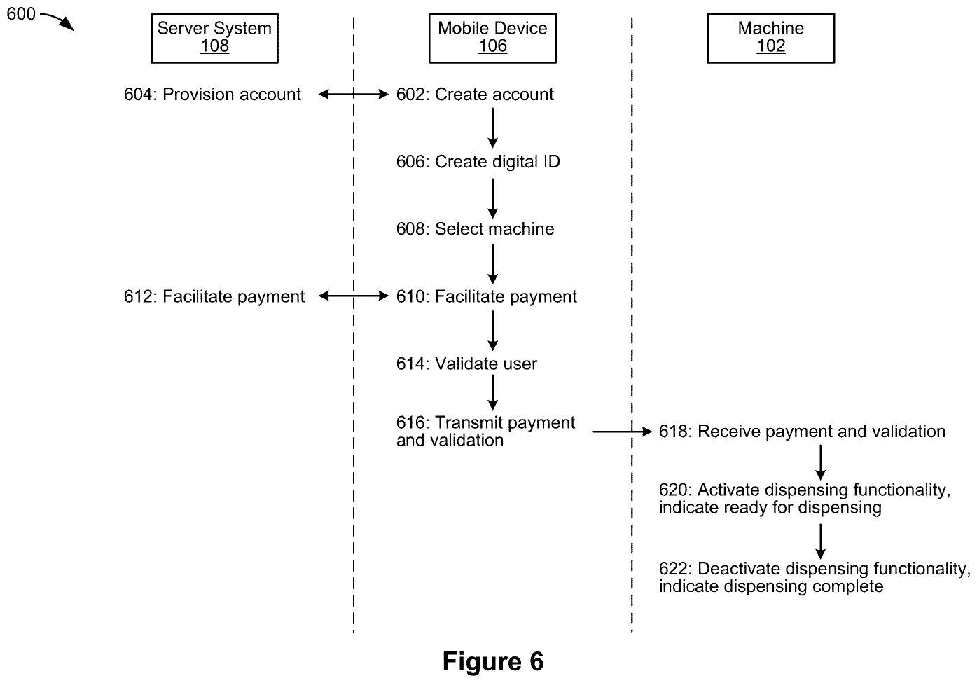

FIG. 6 is a flow diagram of a self-serve dispensing validation method 600 involving a controlled dispensing machine 102, a mobile device 106, and a server system 108 in accordance with some implementations. The method may be governed by instructions that are stored in a computer memory or non-transitory computer readable storage medium respectively corresponding to the controlled dispensing machine 102, the mobile device 106, and the server system 108 (e.g., 220, 320, and 420). The instructions may be included in one or more programs stored in the non-transitory computer readable storage medium. When executed by one or more processors respectively corresponding to the controlled dispensing machine 102, the mobile device 106, and the server system 108 (e.g., 210, 232, 310, and 410), the instructions cause the controlled dispensing machine 102, the mobile device 106, and the server system 108 to perform the process. Each non-transitory computer readable storage medium may include one or more solid state storage devices (e.g., Flash memory), magnetic or optical disk storage devices, or other non-volatile memory devices. The instructions may include source code, assembly language code, object code, or any other instruction format that can be interpreted by one or more processors. Some operations in the process may be combined, and the order of some operations may be changed.

Method 600 is described with reference to FIGS. 7A-7D, which are diagrams depicting example user interfaces of a mobile device 106 associated with a self-serve controlled dispensing environment 100 in accordance with some implementations.

Referring to FIGS. 6 and 7A-7D, a user first creates an account (702) using the mobile device 106, which communicates with the server system 108 to provision the account (604) as described above with reference to operations 502. As part of account creation, an application 322 on the mobile device 106 creates a digital ID (606) as described above with reference to operations 502. The user selects a controlled dispensing machine 102 (608) as described above with reference to operation 504. For example, the user selects Machine A (702) in FIG. 7A, causing a representation 703 of the selected machine to be displayed on the user interface of the application 322 as shown in FIG. 7B. The representation 703 optionally includes descriptions of one or more of the controlled products and/or services available for purchase from the selected machine 102. These descriptions may be obtained from the server system 108 or from the control unit 104 of the selected machine 102.

The user proceeds to send a payment (610) to the control unit 104 of the selected machine 102 by selecting a user interface element 704 corresponding to an option to provide payment to the machine. The application 322 on the mobile device 106 communicates with the server system 108 to facilitate the payment (612) as described above with reference to operation 506. The application 322 validates the user (614) by performing a biometric check to verify the user's identity and/or age using the reusable digital ID prior to sending the payment and age-verified credentials to the selected machine 102, as described above with reference to operations 512 and 514. For example, selection of the payment element 704 in FIG. 7B causes the application 322 on the mobile device 106 to perform a biometric FaceID operation 706 as shown in FIG. 7C.

Upon successfully validating the user in operation 614, the application 322 on the mobile device 106 transmits the payment and validation credentials (616) to the control unit 104 of the selected machine 102, as described above with reference to operation 514. When the control unit 104 of the selected machine 102 receives the payment and validation credentials (618), the control unit 104 causes the machine 102 to activate its dispensing functionality and optionally indicate to the user that the machine is ready for dispensing (620). In some implementations, the control unit 104 first determines that (i) the payment meets a threshold for dispensing the controlled product or service to the user (e.g., enough funds were transferred to the cover the cost of the product or service), and/or (ii) the verification credential indicates that the user satisfies a legal compliance condition (e.g., the user meets a legal minimum age requirement).

For example, the application 322 on the mobile device 106 displays a message 608 for the user, instructing the user how to proceed with the dispensing operation (e.g., “select a tap”), while the machine 102 activate one or more visual indicators 105 (FIG. 1) indicating to the user that the desired product and/or service may be dispensed and/or obtained. For example, lights 105 alongside the beer taps 107 may illuminate indicating to the user that the user may select a desired beer tap and begin pouring the beer out of the selected tap.

From the point of view of the user, the lights 105 illuminate upon successful payment and validation of the user. In some implementations, the control unit 104 of the machine 102 may deactivate the dispensing functionality and indicate dispensing is complete (622). This may be in response to a timer or some other measure of the amount of dispensed product and/or service. For example, the light corresponding to the selected tab may remain illuminated, or may be illuminated a certain color (e.g., blue) for as long as the control unit 104 determines that an amount of beer required to fill a glass has not yet been dispensed. In some implementations, the lights corresponding to unselected taps 107 may turn off when the selected tap is activated, indicating that the selection has been made. When the control unit 104 determines that enough beer has been dispensed to fill a glass, the control unit 104 may cause the light 105 corresponding to the selected tap 107 to turn off, or to be modified by illuminating a different color (e.g., red) indicating the drink has been poured and the dispensing operation is complete.

In some implementations, the application 322 and server system 108 also implement functionality for clerk authentication, purchase limits, and consumer criteria as described with reference to FIGS. 13-15 in U.S. patent application Ser. No. 18/775,914 (incorporated by reference). In some implementations, the application 322 and server system 108 also implement functionality for remote validation as described with reference to FIGS. 22-25 in U.S. patent application Ser. No. 18/775,914 (incorporated by reference). In some implementations, the application 322 and server system 108 also implement functionality for remote clerk verification procedures as described with reference to FIGS. 26-27E in U.S. patent application Ser. No. 18/775,914 (incorporated by reference).

In some implementations, the controlled dispensing environment 100 described herein implements an age-gated payment system that enables an improved self-service experience, by transforming traditional beverage pour bars into smart, compliant self-pour experiences, all through the convenience of a user's smartphone. In some implementations, an adapter module (e.g., 230) may simply be installed on an existing pour tap, enabling the equipment to accept both mobile payment and age-verification. With the functionality provided by the processing module 230, application 322, and server system 108, no network connectivity required between the machine 102 and a server is required since the system leverages the short-range connectivity provided by the consumer's mobile device 106, which means less risk to business and more flexibility in machine installation locations. However, the machine 102 may optionally directly communicate with one or more servers through the communication network(s) 110 in other implementations.

The disclosed system provides an in-app one-time age verification process that gives consumers long-term access (no need to rely on staff for manual ID checks or issuing of RFID cards). Further, both payment and age-verification may be performed within the consumer's smartphone, which results in improved operational efficiency. Lastly, no expensive hardware at the location of the machine 102 is required. No payment terminal, digital screen, wall space, scanner, or equipment is required other than the processing module 230, which provides a plug-and-play solution that integrates seamlessly into any beer tap dispenser without the need for complex equipment.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

1. A self-service controlled dispensing system comprising:
a mobile device including one or more processors and memory storing one or more programs for execution by the one or more processors, the one or more programs including instructions that cause the one or more processors to:
create a user account, including verifying an age or identity of the user and securing the user account with biometric validation;
create a digital identification based on the verified age or identity and store the digital identification in the memory of the mobile device;
identify one or more controlled dispensing machines in proximity to the mobile device;
receive a user selection of a first controlled dispensing machine of the one or more identified controlled dispensing machines;
receive a user request to send a payment to the first controlled dispensing machine;
in response to the user request to send the payment to the first controlled dispensing machine, validate the user with a biometric check;
in accordance with a successful user validation, transmit (i) the payment and (ii) a verification credential corresponding to the digital identification to the first controlled dispensing machine, enabling the first controlled dispensing machine to dispense a controlled product or service to the user.

2. The self-service controlled dispensing system of claim 1, wherein the instructions further cause the one or more processors to validate the user with the biometric check by comparing a result of the biometric check with the digital identification stored in the memory.

3. The self-service controlled dispensing system of claim 1, wherein the user selection of the first controlled dispensing machine causes a representation of the first controlled dispensing machine to be displayed on a display of the mobile device.

4. The self-service controlled dispensing system of claim 3, wherein the representation of the first controlled dispensing machine displayed on the display of the mobile device includes a user interface element that, when selected, triggers the user request to send the payment and the validation of the user with the biometric check.

5. The self-service controlled dispensing system of claim 3, wherein the instructions further cause the one or more processors to display a message on the display of the mobile device with dispensing instructions in accordance with the successful user validation.

6. The self-service controlled dispensing system of claim 1, further comprising:
the first controlled dispensing machine, wherein the first controlled dispensing machine includes one or more processors and memory storing one or more programs for execution by the one or more processors, the one or more programs including instructions that cause the one or more processors to:
receive the payment and the verification credential from the mobile device; and
in accordance with a determination that (i) the payment meets a threshold for dispensing the controlled product or service to the user, and (ii) the verification credential indicates that the user satisfies a legal compliance condition, cause the controlled product or service to be dispensed to the user.

7. The self-service controlled dispensing system of claim 6, wherein the instructions included in the memory of the first controlled dispensing machine further cause the one or more processors of the first controlled dispensing machine to:
enable a visual signal indicating to the user that the controlled product or service is ready to be dispensed; and
cause the controlled product or service to be dispensed in response to a user interaction with a dispensing mechanism of the first controlled dispensing machine.

8. The self-service controlled dispensing system of claim 6, wherein the instructions included in the memory of the first controlled dispensing machine further cause the one or more processors of the first controlled dispensing machine to:
in accordance with a determination that a dispensed amount of the controlled product or service as reached a dispensing threshold, modify the visual signal and cause the controlled product or service to cease being dispensed to the user.

9. The self-service controlled dispensing system of claim 6, wherein the first controlled dispensing machine is a self-serve pour system, and the controlled product or service is an alcoholic beverage.

10. The self-service controlled dispensing system of claim 6, wherein the threshold for dispensing the controlled product or service is a price of a single alcoholic beverage, and the legal compliance condition is a legal minimum drinking age.

11. A self-service controlled dispensing method comprising:
at a mobile device including one or more processors and memory:
creating a user account, including verifying an age or identity of the user and securing the user account with biometric validation;
creating a digital identification based on the verified age or identity and storing the digital identification in the memory of the mobile device;
identifying one or more controlled dispensing machines in proximity to the mobile device;
receiving a user selection of a first controlled dispensing machine of the one or more identified controlled dispensing machines;
receiving a user request to send a payment to the first controlled dispensing machine;
in response to the user request to send the payment to the first controlled dispensing machine, validating the user with a biometric check;
in accordance with a successful user validation, transmitting (i) the payment and (ii) a verification credential corresponding to the digital identification to the first controlled dispensing machine, enabling the first controlled dispensing machine to dispense a controlled product or service to the user.

12. The self-service controlled dispensing method of claim 11, wherein validating the user with the biometric check includes comparing a result of the biometric check with the digital identification stored in the memory.

13. The self-service controlled dispensing method of claim 11, wherein the user selection of the first controlled dispensing machine causes a representation of the first controlled dispensing machine to be displayed on a display of the mobile device.

14. The self-service controlled dispensing method of claim 13, wherein the representation of the first controlled dispensing machine displayed on the display of the mobile device includes a user interface element that, when selected, triggers the user request to send the payment and the validation of the user with the biometric check.

15. The self-service controlled dispensing method of claim 13, further comprising displaying a message on the display of the mobile device with dispensing instructions in accordance with the successful user validation.

16. The self-service controlled dispensing method of claim 11, further comprising:
at the first controlled dispensing machine:
receiving the payment and the verification credential from the mobile device; and
in accordance with a determination that (i) the payment meets a threshold for dispensing the controlled product or service to the user, and (ii) the verification credential indicates that the user satisfies a legal compliance condition, causing the controlled product or service to be dispensed to the user.

17. The self-service controlled dispensing method of claim 16, further comprising:
at the first controlled dispensing machine:
enabling a visual signal indicating to the user that the controlled product or service is ready to be dispensed; and
causing the controlled product or service to be dispensed in response to a user interaction with a dispensing mechanism of the first controlled dispensing machine.

18. The self-service controlled dispensing method of claim 16, further comprising:
at the first controlled dispensing machine:
in accordance with a determination that a dispensed amount of the controlled product or service as reached a dispensing threshold, modifying the visual signal and cause the controlled product or service to cease being dispensed to the user.

19. The self-service controlled dispensing method of claim 16, wherein the first controlled dispensing machine is a self-serve pour system, and the controlled product or service is an alcoholic beverage.

20. The self-service controlled dispensing method of claim 16, wherein the threshold for dispensing the controlled product or service is a price of a single alcoholic beverage, and the legal compliance condition is a legal minimum drinking age.
